(19) United States
(12) Patent Application Publication
(10) Pub. No.: US 2012/0317505 A1
(43) Pub. Date: Dec. 13, 2012

(54) SYSTEM AND METHOD FOR PUBLISHING RECIPES ON AN ONLINE MEDIUM

(76) Inventors: Jonah Schwartz, San Francisco, CA (US); Jane Goldman, San Francisco, CA (US)

(21) Appl. No.: 13/156,114

(22) Filed: Jun. 8, 2011

(51) Int. Cl. G06F 3/048

(52) U.S. Cl. 715/764

(57) ABSTRACT

Embodiments described herein enable recipe authors to create enhanced and functional recipe content which can be published in an online medium or environment of their specification.

### TECHNICAL FIELD

Embodiments described herein pertain to a system and method for publishing content, and more specifically, a system and method for publishing cooking recipes in an online medium.

### BACKGROUND

Web environments enable functionality and interaction for various forms of content. With advancement, the usability of such mediums to publish content has increased.

### BRIEF DESCRIPTION OF THE DRAWINGS

FIG. 1 illustrates a system for enabling recipe authors to create and publish recipes in an interactive, online medium, according to one or more embodiments.

FIG. 2 illustrates a computer-implemented method for enabling individuals to create and publish recipes online, according to one or more embodiments.

FIG. 3 illustrates another computer implemented method for publishing recipes in an online environment, according to one or more embodiments.

FIG. 4 illustrates a presentation for an interactive recipe, according to an embodiment.

FIG. 5 is a block diagram that illustrates a computer system upon which embodiments described herein may be implemented.

### DETAILED DESCRIPTION

Embodiments described herein include a system and method for enabling recipe authors to create functional and enhanced recipe content or presentations in an online medium.

Additionally, some embodiments described herein enable recipe authors to create enhanced and functional recipe content which can be published in an online medium or environment of the recipe author's selection or specification (e.g., web page, social networking page, etc.).

According to one or more embodiments, information is received from a recipe author regarding one or more steps of a recipe. A functionality is programmatically generated for facilitating use of the recipe by recipe users (those individuals who view or may download the recipe). The recipe specified by the author is enabled for publication or distribution in an online medium.

In one embodiment, a transportable data item is generated that programmatically identifies a particular recipe. The data item can be embedded in an online resource, such as a web page or social networking resource, in order to enable presentation of the identified recipe with subsequent use of the online resource. The data item may be provided with functionality that enables the data item to be triggered with events, such as a user selection of a link on a page in which the data item is embedded or a download of the resource on which the data item is provided.

Still further, embodiments include an interactive presentation generated on a computing environment, on which a functional or enhanced recipe content is presented. The interactive presentation may include a recipe content for a food item. The recipe content identifies (i) a set of ingredients, (ii) quantities of measurements for each of the ingredients in the set, and (iii) instructional content for using the ingredients to prepare the food item. One or more functional components are provided with the recipe content in order to enable alteration or substitution of the set of ingredients, the quantities of measurement, and/or one or more recipe steps that are identified by the instructional content.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or computing devices.

Furthermore, one or more embodiments described herein may be implemented through the use of instructions that are executable by one or more processors. These instructions may be carried on a computer-readable medium. Computers or computing devices shown or described with figures below provide examples of processing resources and computer-readable mediums on which instructions for implementing embodiments of the invention can be carried and/or executed. In particular, the numerous devices shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Computer System

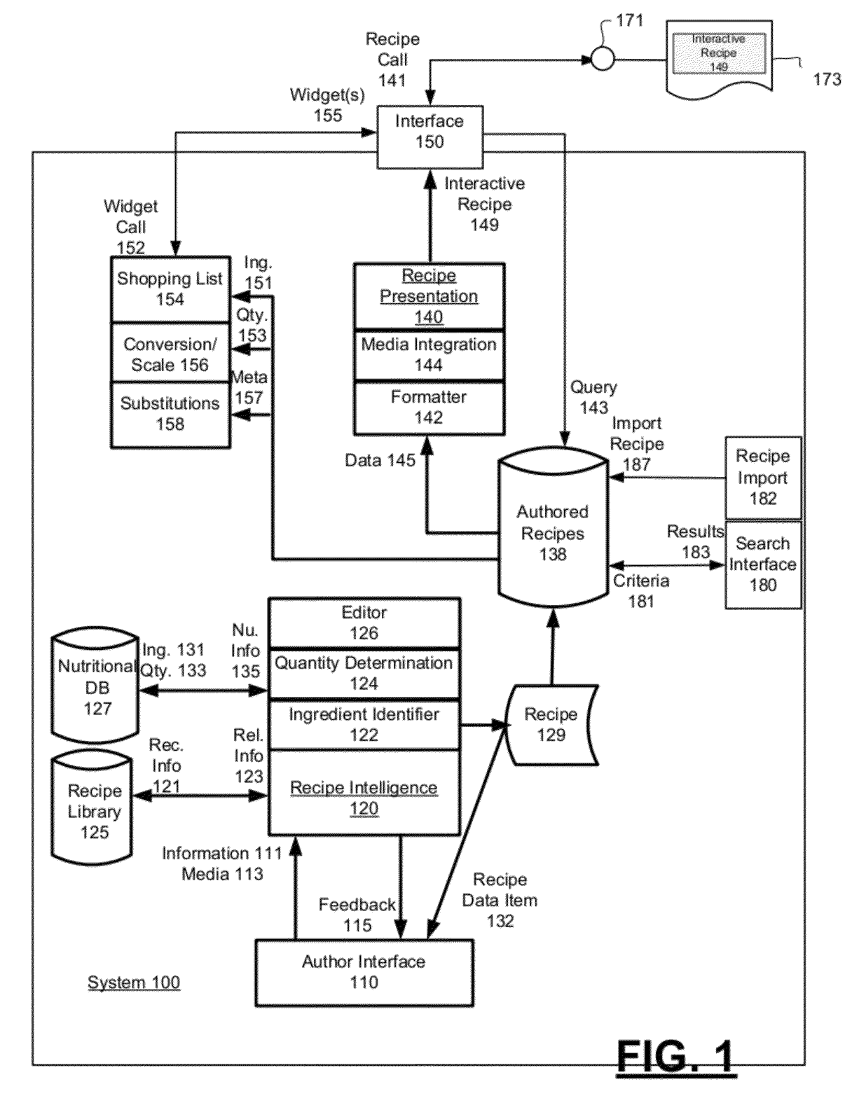

FIG. 1 illustrates a system for enabling recipe authors to create and publish recipes in an interactive, online medium, according to one or more embodiments. In particular, a system 100 enables a recipe author to create and publish an interactive recipe in an online medium selected by the author (e.g., a recipe author's cooking blog). Various embodiments are described to facilitate a recipe author in creating content for a recipe. In particular, recipe authors may include or specify content with recipes that includes media (e.g., images, video), as well as text entered in various forms (e.g., list or paragraph form). Additionally, some embodiments enable users to locate existing recipes stored on system 100 for use and publication at other sites. Thus, users can utilize the system 100 to search for recipes created by others.

According to some embodiments, system 100 facilitates the recipe author in creating the recipe by, for example, (i) formatting the text or content provided, (ii) supplementing recipes with additional information, functionality and services, and/or (iii) making suggestions to the recipe author regarding the use of ingredients, the steps performed or other aspects of a recipe. Additionally, system 100 is adapted to generate a data item 132 for the recipe author to use in order to publish the recipe in an online medium of the author's choosing.

With respect to FIG. 1, system 100 may be implemented as a service, provided through, for example, a website that enables its users to create recipes (utilize the website as a recipe author), and to search and use recipes (recipe users). As a website service, system 100 can be implemented by one or more servers. However, as an alternative or variation, system 100 may be implemented by terminals or computing devices operated by users in alternative networking environments. Still further, some embodiments may be implemented entirely or substantially on standalone computing devices, such as by way of user terminal's program that includes programming and resources described through various embodiments herein.

System 100 includes components or modules that include a recipe author interface 110 and a recipe intelligence 120. The recipe author interface 110 may correspond to functionality that provides the recipe author with input fields, prompts, and other interactive mechanisms in order for the recipe author to enter information 111 about his or her recipe. The information 111 provided by the recipe author may include text, such as instructional text about the contents of a recipe or steps for performing such recipe. As a variation, information 111 provided by the recipe author can also include media 113, including images or video as to how particular portions of the recipe are to be performed or what the food item is supposed to look like. In one embodiment, author interface 110 is provided as a wizard, which can guide the user into entering information for his/her recipe, as well as collect information from the user about the recipe and/or his or her preferences as to how the recipe is to appear.

The recipe intelligence 120 may analyze and/or respond to information 111 and/or media 113 provided from the user about a recipe in order to provide feedback 115 via the interface 110 to the recipe author about the recipe. The feedback 115 can be provided responsively, such as in real-time while the recipe author specifies information/ingredients for the recipe. The feedback 115 can further include, for example, formatted information provided by the user, augmented information/content for the recipe, supplemental information (e.g., alternatives, suggestions), and augmented information.

The sub-components of recipe intelligence 120 can include an ingredient identifier 122 and a quantity determination 124. In one embodiment, the recipe intelligence 120 includes or utilizes programming logic of the ingredient identifier to parse and/or analyze the user's text in order to identify words that correspond to ingredients (e.g., butter, beans, milk, meat, etc.). In other implementations, the author interface 110 may designate specific fields for user input as being ingredient lists. Thus for example, the recipe author may be presented with a field that requires the author to list all the ingredients in the recipe.

In similar fashion, programming logic corresponding to quantity determination 124 identifies text or characters that correspond to quantity of a particular ingredient. Examples include fractions, words that are known to refer to quantities in recipes (e.g., cups, pinch, ‘tsp’) or alphanumeric representations of numbers (e.g., ‘1’). In one variation, the author interface 110 displays designated fields in which the user must specify quantity for an ingredient. Rather, than use intelligence to identify quantity, in an alternative implementation, the interface 110 may cause the user to specify which items in a recipe correspond to a quantity. In this manner, the recipe author is able to tag the portions of the recipe that correlate to quantity.

According to some embodiments, recipe intelligence 120 is able to use an ingredient list (set of ingredients determined from the recipe author's information) and corresponding quantity statements to (i) facilitate the user's creation of a recipe, (ii) supplement or augment the user's recipe with additional information and/or suggestions (or alternatives), and (iii) provide additional functionality in connection with an interactive recipe.

In some variations, recipe intelligence auto-completes the user's recipe or recipe steps. For example, in popular recipes, the last series of steps may be well known, and the recipe intelligence 120 may generate steps to present to the user as suggestions via the interface 110. Likewise, common steps may be auto-completed in a similar fashion.

In some embodiments, recipe intelligence 120 accesses various recipe resources in order to make suggestions or recommendations as to the specifics in the recipe being created by the recipe author. In one embodiment, recipe intelligence 120 compares specific recipe information 121 of the recipe being created to recipes and/or recipe resources stored in a recipe library 125 in order to identify relevant information a particular recipe. For example, the recipe intelligence 120 may be adapted to structure a query from recipe information 121 in order to retrieve the information 123 from the recipe library 125.

The recipe information 121 can correspond to, for example, (i) a dish that is to be prepared from the recipe, or (ii) individual ingredients specified by the author for a recipe. The relevant information 123 that can be retrieved from the recipe library 125 can include, for example, ingredients or instructions specified in other recipes for the same or similar dishes. As a more specific example, the user may enter ‘cocoa powder’ as an ingredient. Recipe intelligence 120 can identify the ingredient, and based on the ingredient identification or other information that may be know about the recipe, retrieve information about a recommended type (e.g., dark chocolate, 75% cocoa) or brand of the particular ingredient. In some implementations, the recipe intelligence 120 accesses other similar recipes (e.g., recipes for similar or same dishes) to identify specific ingredients used, or access a genre of recipes or cuisine types in order to make such determinations. The recipe intelligence 120 may retrieve the specific information about the ingredient as a basis for making a recommendation to the recipe author. In this regard, the recipe author may specify specific types of ingredients, and a recipe intelligence 120 may suggest alternatives that have been used in other similar recipes or are otherwise known for the particular ethnicity/cuisine type.

In addition to making recommendations as to a particular type of ingredient, one or more embodiments may also suggest alternatives to ingredients or quantities specified by the user. For example, the recipe intelligence 120 may specify that a healthy alternative to using ground beef is to use lean ground beef, ground turkey, or grown pork. Furthermore, links or information may be provided to the user as to resources to validate the suggestion being made. In some embodiments, the recipe intelligence 120 may also notify the user if the recipe author's specifications are outside of the norm in a particular manner. For example, the recipe intelligence 120 may measure the quantities of the ingredients and identify when there is too much meat or salt (as compared to an average specified in other similar recipes).

The recipe intelligence 120 may also determine when additional steps or ingredients can be beneficial. For example, the recipe intelligence 120 may specify when the use of a particular ingredient, such as sugar, may enhance the flavor, etc. of a particular dish. Still further, recipe intelligence 120 may add or suggest alternative steps to the steps being provided by the recipe author. For example, if the recipe author specifies cooking at a particular temperature, the recipe intelligence 120 may access resources to determine (e.g., from popular recipes on the same dish) that a slow cooked methodology may be preferred.

The various feedback 115 provided from the recipe intelligence 120 (e.g., recommendations, suggestions, information provided by the recipe intelligence 120) can be based on other recipes that the recipe intelligence 120 accesses. Recipes that are used for comparison purposes can be evaluated on the basis of, for example, popularity (e.g., highly ranked recipes are those that have been downloaded the most) or credibility (e.g., they are from authors who have credentials such as expertise in an area of cuisine).

Still further, information such as ingredients and quantity may be used to augment information provided with the recipe. For example, the ingredient list 131 and corresponding quantities 133 specified by the recipe author can be used to retrieve nutritional information 135 from a nutritional database 127. This information may be stored in association with the particular recipe created, recipe author. In this way, certain nutritional information, such as calories or grams of fat, may be published when a recipe is completed.

In addition, some embodiments facilitate the user's creation of the recipe through formatting and/or editing. For example, alternative ways are available for presenting a recipe. In some geographic regions (e.g., United States), recipe formats are in list form. But in other places, recipes are sometimes presented in paragraph form. Accordingly, system 100 may include programming logic in the form of an editor 126, which includes functionality for automatically formatting a user's recipe creation into a particular recipe format, such as list form, paragraph form, a hybrid list/paragraph form, and/or other varieties. Still further, the editor 126 can analyze the semantics provided by the recipe author to make corrections or suggestions as to the wording used.

By entering information 111, the recipe author is able to create a recipe of their choosing. The process by which the recipe author enters information 111 and content 113 for a recipe can be interactive, educational, and one that enables the user to express creativity. For example, the user can upload media 113 in the form of pictures and videos that are instructional as to performing steps specified in his or her recipe. Furthermore, the user may access other resources, such as videos of other persons performing recipe steps, movie clips, etc., in order to create an interactive experience about his or her recipe. Such videos and images may be displayed in connection with specific steps of the user's recipe. The specific steps that comprise the recipe can also be selectable by a recipe user in order to display additional information and content, such as media, paragraph descriptions and other information.

Once the recipe author has completed a recipe 129, the recipe can be stored in a recipe database 138. The information stored in the recipe database 138 can also include various information determined from a user's recipe. This information can include, for example, suggestions, alternatives and nutritional information, as determined by the recipe intelligence 120. The information stored in connection with the particular recipe 129 may be determined at the time the recipe 129 is created (e.g., presented to the recipe author in real-time), or subsequent determined after the recipe author has created the recipe 129 and elected to store it on system 100.

According to embodiments, the recipe database 138 stores recipes provided from multiple sources. As described, for example, recipe creators can create and store recipes via the author interface 110. In other variations, an import tool 182 can be used to import recipes from other sources, such as those published on sites outside of the domain of the system 100, or in recipe books (which can be digitally scanned). The import tool 182 can, for example, programmatically scan content to identify recipe steps (including ingredients and measurements), as well as the recipe name or title, and other meta-information (such as the recipe author). The import tool 180 can then store the recipe in the database 138 for use by recipe users. In some variations, the import tool 182 operates automatically, by crawling sites and/or checking specific network locations (e.g. chef blogs) for content that it can identify as being a recipe. In such cases, the import tool 182 can operate with intelligence to detect if content is a recipe (e.g. scan for the word “recipe” or “dish”), as well as steps that comprise the recipe once it is identified.

With regard to the various usage scenarios described on importing recipes (or using recipes created by others), embodiments assume that the storage, reproduction or modification of such recipes is with permission from the proper entities (e.g. copyright holders).

Recipe Publication

According to embodiments, system 100 enables the user to publish a recipe on an online medium of their choosing. In particular, a user can publish a recipe of his or creation, or alternatively, use system 100 to locate and publish (or modify and publish) an existing recipe stored with system 100 (e.g. a recipe created by another, imported recipe etc.). Accordingly, one or more embodiments may generate data item 132 that is associated uniquely with the recipe 129 created by the recipe author. The data item 132 is structured to be transportable (or deliverable) to a location specified by the recipe author. The data item 132 may correspond to a trigger that the recipe author can embed into a particular webpage, such as a blog, or social networking page. The data item is triggered when the page that carries the data item 132 is downloaded. When triggered, the downloaded web page, or the network resource that hosts the web page, initiates an interaction with system 100 in which the recipe 129 is presented to the user viewing the page (the recipe user). According to some embodiments, the recipe presentation is provided in an enhanced and interactive form, with various formatting functionality and/or media as specified or provided by the recipe author.

More specifically, in response to the data item 132 being triggered, the downloaded web page or host resource can interact with system 100 by generating a recipe call 141. The data item 132 may include scripts or other functionality that initiates a programmatic sequence with an interface 150 of system 100 (or other remote functionality associated with system 100). The programmatic sequence generates the recipe call 141 which identifies the recipe 129. The interface 150 handles the call 141 by querying 143 the database 138 for the identified recipe 129. Data 145 corresponding to the recipe and its associated information is identified from the query 143. The recipe data 145 may be generated within system 100 to include or be packaged with functionality, which can be communicated to the remote location 171 where it is presented as an interactive recipe 149 on the web page 173.

In one embodiment, the interface 150 accesses the database 138 of recipes for the recipe 129 identified by the call 141. Additionally, the recipe call 141 can trigger operation of a recipe presentation component 140, which can reside on system 100. In alternative implementations, the presentation component 140 is signaled from system 100 to the site 171, along with recipe data 145.

The presentation component 140 can perform formatting operations for presentation of the interactive recipe 149 as identified by recipe data 145. In addition, the presentation component 140 can enhance and/or augment presentation of the interactive recipe 149 (corresponding to recipe 129) with additional information and/or content. The resulting recipe 149 is interactive in that it can be published with links and objects (e.g., media specified by the recipe author) to provide content and information on the recipe. Furthermore, the interactive recipe 149 may be packaged or otherwise provided with widget functionality to supplement or augment information provided with, for example, nutritional information, shopping lists, conversion units and scaling.

According to one or more embodiments, the recipe presentation component 140 includes functionality that can reside on, for example, system 100, or that can be signaled to run on the page on which the data item 132 is provided. In one embodiment, the recipe presentation component 140 includes functionality corresponding to a formatter 142 which formats presentation of the recipe 129 at the remote location in accordance with parameters or designations specified by the recipe author (or alternatively the recipe user). Additionally, recipe presentation component 140 may include a media integration component 144 that integrates media objects with portions of the recipe (e.g., recites steps of the recipe).

Additionally, one or more embodiments enable the use of recipe widgets 155 with publication of recipe 129 at the remote web page. In response to a widget call 152 (which can be part of the recipe call 141), various functionality may be provided with or in connection with the interactive recipe 149, presented to the recipe user (e.g., on the recipe user's webpage).

In some embodiments, the widget functionality includes a shopping list 154. The shopping list 154 identifies the ingredients 151 and quantities 153 specified in the interactive recipe 149, and presents the ingredients to the recipe user in a shopping list form. In addition to the shopping list 154, some embodiments include conversion or scale functionality 156. The conversion or scale functionality 156 enables the recipe user to (i) after conversion units for the quantities 153 specified in the interactive recipe 149, and/or (ii) after the scale specified by the recipe. Conversion units may be altered from, for example, teaspoons or cups to grams. The scale of the recipe 129 may be increased or decreased based on the number of persons the recipe user wishes to provide for. For example, the recipe author may publish one recipe for two users as default. The conversion scale 156 may alter the specified quantities for larger or smaller parties as specified by the recipe user. For example, the recipe user may use the conversion or scale functionality 156 to prepare a dish for 12 persons, while another user uses the functionality 156 to prepare the dish of the recipe for two persons.

Additionally, functionality provided with the widget 155 can include substitutions 158, which identify certain ingredients or steps that may have alternatives or substitutions, based on various criteria for making substitutions. For example, information (metadata 157) determined from recipe intelligence 120 may be used by the widget 155 to make recommendations or suggestions as to a particular type of recipe, substitutions, additions, or alternatives, as known from popular recipes or recipes experts. Other considerations include, healthy alternatives (where certain ingredients that are known to be unhealthy is substituted with ingredients that are known to be healthier), or substitutions for religious preferences.

In this way, the recipe author is able to create and publish a recipe in an online medium of the choosing. A service may be used at a website, for example, to facilitate the creation of the recipe in an enhanced form. In some variations, the recipe can be created with the use of instructional media, as well as supplemental information such as nutritional information or substitutions. Furthermore, the recipe author may receive programmatic assistance in writing text and formatting the text and or media provided with the recipe.

Recipe Search and Discovery

According to one or more embodiments, a search interface 180 may be provided with memory resources that store user recipes. In FIG. 1, for example, the recipe database 138 may be coupled to an interface 180 that enables recipe users to search for recipes by criteria 181, who in turn, receive recipe results 183. The recipe users may coincide with, for example, visitors who access a network location of system 100.

The search criteria 181 can specify recipes in a variety of ways. In embodiments, the recipe user may specify by dish, genre (e.g., Chinese), ingredients, nutritional information (under 600 calorie meal), or recipe author. Some information that makes the recipes searchable may be associated with the recipes through analysis, or recipe author input. For example, the recipe author may specify the nutritional information of ingredients, or alternatively, the recipe information specified by the recipe author may be programmatically analyzed and compared to the nutritional database 127 in order to identify nutritional information that is stored in association with the recipe.

In some variations, recipe users can use the search interface 180 to search for recipes based on similarities. For example, a user may seek recipes for a common dish and recipes that are similar to one another in content (e.g., similar ingredients).

As an alternative or variation, some embodiments enable users to locate and publish existing recipes (i.e. created by others). In one embodiment, a user can search, for example, authored recipe database 138 using search interface 180. A searcher may include search criteria, such as a name of a recipe or dish, the name or identifier (e.g. online moniker) of a chef or recipe creator, one or more ingredients that comprise a desired recipe, and/or a category designation for the recipe (e.g. Cajun or Cajun chicken). Still further, the search may parse or limit the search based on criteria such as nutritional information, ingredient list, or dietary restrictions. In an embodiment in which users can search and locate recipes, the located recipe can be published at a location specified by the searcher. For example, the searcher can locate a recipe and publish it on a social network page or blog.

As another variation, the search may locate a recipe and modify it for publication. For example, a user may locate an existing recipe and then modify the recipe by (i) adding or substituting ingredients, and (ii) incorporating additional text to describe the steps of the recipe performance. The searcher may also specify additional information (e.g. nutritional information) or apply functionality from the widget 155 in order to save and publish the recipe at a desired site or location (e.g. blog).

Methodology

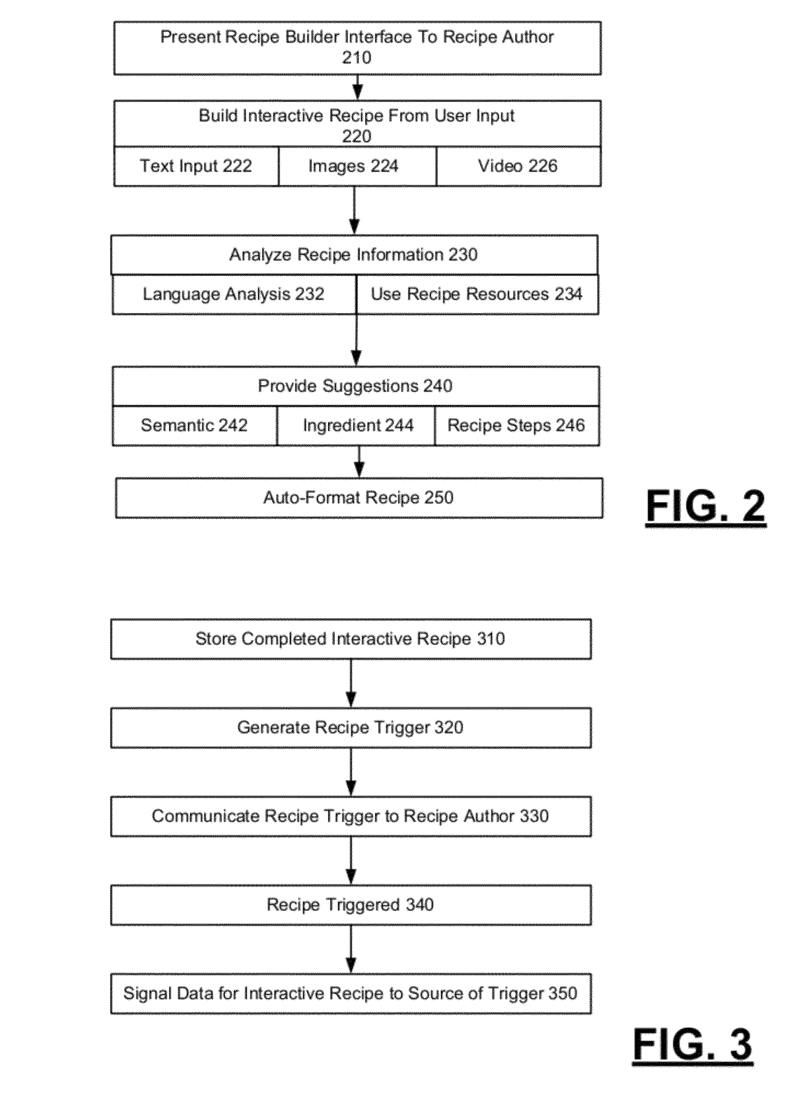

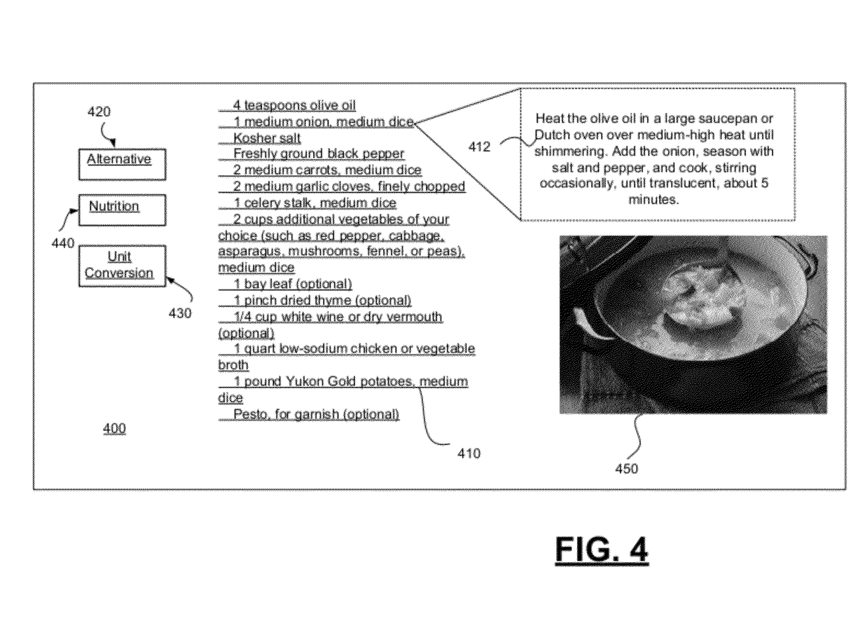

FIG. 2 illustrates a computer-implemented method for enabling individuals to create and publish recipes online, according to one or more embodiments. FIG. 3 illustrates another computer implemented method for publishing recipes in an online environment, according to one or more embodiments. Embodiments such as described with FIG. 2 and FIG. 3 may be implemented using components such as described with an embodiment of FIG. 1. Accordingly, reference is made to elements of FIG. 1 for purpose of illustrating components for performing a step or sub-step being described.

With reference to FIG. 2, an interface is presented to a user to facilitate the recipe author to build a recipe for online publication or distribution (210). In one implementation, author interface 110 provides an online wizard from which the author can use to enter text and other content for the recipe. As a variation, the wizard may be adapted to structure the user input so that the input is formatted. Similarly, if the user omits necessary information, such as measurement quantities or necessary or common steps (e.g., for popular recipes, important ingredients may be pre-established), the wizard can prompt the user for the omitted information.

The recipe author builds the recipe by supplying information and content (220). The information and content can include text input (222), image input (224), and/or video input (226). For example, the recipe author can upload images to show the dish as prepared by the author. Media such as images and video can also be used to illustrate intermediate steps and/or ingredients for use in completing the recipe. Media may also be used to illustrate how the dish should be arranged in an aesthetically pleasing manner or how the finished dish should look like (e.g., color, shapes).

Information provided by the recipe author can be analyzed programmatically (230). The information provided by the recipe author can be processed for words or terminology specified in the author's input (232). For example, the recipe intelligence 120 may parse the information provided by the user to identify ingredients and quantities.

Additionally, the identified information can be used to query recipe resources (234), such as the library of recipes. For example, recipe information may be analyzed by comparing the ingredients identified from the recipe author's input to ingredients of known recipes for the same dish (as provided by others or experts). Alternatively, the recipe information may be analyzed by comparing how ingredients specified in the recipe under construction are used in other recipes for other dishes. Still further, quantities or measurement identified from the language analysis can be compared to recipe resources for validation of the quantities used, or other comparisons. For example, the user's use of oils or salts may be compared to other recipes in order to identify when the user is providing a low-sodium option, or using too much salt.

In one embodiment, contemporaneously with the recipe author creating the recipe, programmatic suggestions are made to the recipe author (240). In one embodiment, the suggestions include semantic suggestions (242). For example, the user's grammar or terminology may be analyzed, and feedback may be provided to the recipe author regarding alternative terminology or grammar.

Additionally, some embodiments provide ingredient suggestions (244). The ingredient suggestions may take the form of (i) brand or type suggestions, (ii) additional ingredients (programmatic suggestion for an ingredient not specified by the author), or (iii) ingredient substitutions or alternatives. The ingredient substitutions/alternatives may specify substitutes to enhance taste or flavor, promote health, or comply with dietary preferences.

Still further, some embodiments include programmatic suggestions for recipe steps (246). Suggestions for recipe steps include, for example, alterations to how a recipe step is to be performed. For example, the recipe author may specify a number of minutes that a sauce is to heat. The recipe intelligence 120 may utilize recipe resources to suggest an alternative time or temperature. Suggestions for recipe steps may also include additional steps that the user can specify to enhance the recipe (as identified by similar recipes). Still further, suggestions may take the form of substitutions of steps.

The finalized recipe may be programmatically formatted to be presented in a rich, interactive form (250). Furthermore, the recipe may be presented in a default or user designated recipe format (e.g., list form versus paragraph). In one implementation, the recipe author can specify formatting particulars, such as font, color, media objects, etc., in order to control the appearance of the how the recipe is presented on an online medium of his or her choosing. The formatting particulars can further specify content and stylistic input of the author.

In FIG. 3, a completed interactive recipe is stored for subsequent publication (310) at a location specified by the recipe author. In one implementation, the recipe is stored at a network location for system 100 (where the service is provided). The interactive recipe is stored with data that includes content and functionality as described with, for example, an embodiment of FIG. 1. The recipe can be created by a recipe author, as described with, for example, an embodiment of FIG. 2.

Alternatively, the recipe may derive from another source, such as a recipe created by another, a recipe that is imported from another site, or a recipe that is identified in the digital publication of a recipe book. In the latter case, the recipe may be tokenized into text, then functionalized by components such as described with system 100 (see FIG. 1). As such, an embodiment for functionalizing and/or publishing recipes may apply to recipes that are created by users other than the publisher, including with recipes imported from other sites.

For a completed recipe, system 100 generates a recipe trigger or data item 132 (320). Once generated, the recipe data item 132 can be communicated to the author (330). For example, in one embodiment, the data item 132 can be provided in a format from which the user can copy and paste onto, for example, a source for a web page. The embedded data item 132 can trigger and generate an interaction between the web page, or hosting resource of the web page, and resources of (or associated with) system 100.

Once the data item 132 has been created, it is uniquely associated with the recipe specified by the recipe author. The recipe author can, for example, copy and paste the data item onto an embedded webpage, such as the recipe author social networking page, blog, or other network resource. The data item 132 is made to link the recipe created by the author to the network resource specified by the author.

In one implementation, the data item 132 serves as a trigger to call the interactive recipe and its associated functionality at a remote location (specified by the recipe author) (340). The data item may be triggered in a variety of ways. In one implementation, the data item 132 can present a link for recipe that a recipe viewer can select in order to view the interactive recipe associated with the data item 132. In an alternative implementation, the data item 132 is embedded on a network resource specified by the recipe author.

The data item 132 serves as a trigger by which the recipe identified by the data item is called and is then presented automatically with a page download (350). In one implementation, the data item 132 is triggered by, for example, a page download to initiate a series of interactions with system 100. The interactions result in publication of the recipe author's interactive recipe on the downloaded page. In this way, a viewer of the recipe author's resource can view the interactive recipe of the recipe author by, for example, the simple act of viewing the recipe author's webpage.

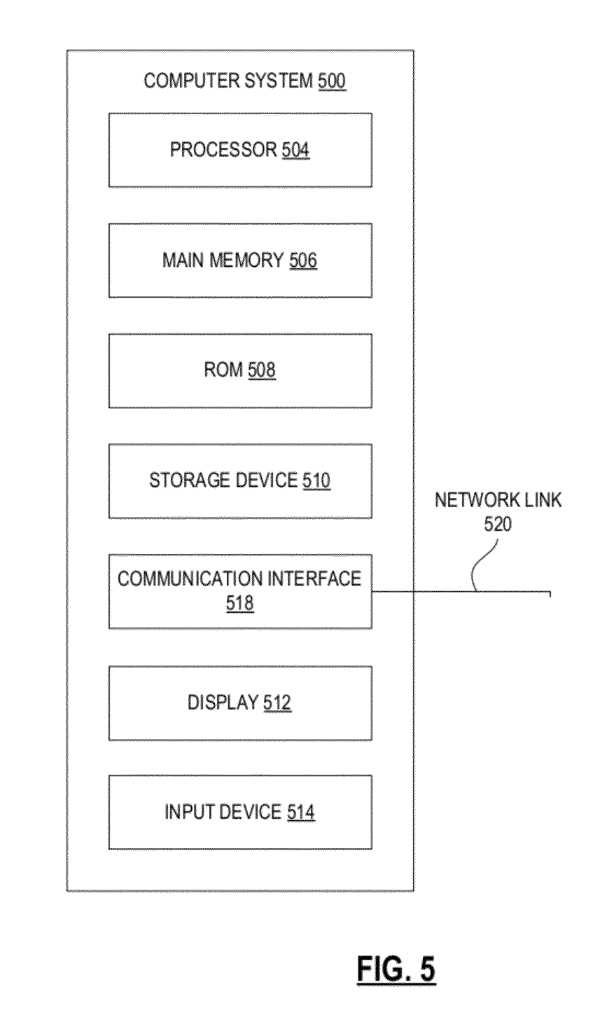

FIG. 4 illustrates a presentation for an interactive recipe, according to an embodiment. An interactive recipe presentation 400 can be generated using, for example, system 100. The interactive recipe presentation 400 may be generated as part of a presentation in an online medium, such as on a web page, or provided as content in a web application. In some embodiments, the location of the presentation 400 can correspond to a network site or location that is specified by the recipe author. In this way, the recipe can be published from one or more network locations as selected by the recipe author.

The recipe presentation 400 includes recipe steps 410, which can be formatted as line items (as shown), or alternatively presented in paragraph form. In one implementation, the recipe steps 410 can be presented and linked to various content, including text description 412 of the recipe, media objects 450 (e.g., an image or video clip) depicting steps (or ingredients or final product), or even links to shopping sites for ingredients that are recited in the recipe 400.

In addition, some embodiments include functionality that augment or supplement the recipe information presented with the recipe presentation 400. Such functionality includes: (i) generate alternative ingredients or steps to those presented 420, (ii) display nutrition information about the recipe or its ingredients 440, (iii) display ingredient substitutions; (iv) display recipe step alterations or variations, (v) make alternative suggestions for preparation (or performing recipe steps), (vi) enable programmatic re-scaling of quantities to accommodate different size parties, (vii) enable programmatic unit conversions to accommodate preferences or geography 430; (viii) enable media object posting and viewing to illustrate recipe steps created by users; (ix) enable formatting of the recipe (e.g. allow recipe user to switch from list format to paragraph format); and/or (x) generate shopping lists from ingredients and quantities specified in the recipe.

FIG. 5 is a block diagram that illustrates a computer system upon which embodiments described herein may be implemented. For example, in the context of FIG. 1, system 100 may be implemented using a computer system such as described by FIG. 5.

In an embodiment, computer system 500 includes processor 504, main memory 506, ROM 508, storage device 510, and communication interface 518. Computer system 500 includes at least one processor 504 for processing information. Computer system 500 also includes a main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) 508 or other static storage device for storing static information and instructions for processor 504. A storage device 510, such as a magnetic disk or optical disk, is provided for storing information and instructions. The communication interface 518 may enable the computer system 500 to communicate with one or more networks through use of the network link 520 (e.g., wired or wirelessly).

Computer system 500 can include display 512, such as a cathode ray tube (CRT), a LCD monitor, and a television set, for displaying information to a user. An input device 514, including alphanumeric and other keys, is coupled to computer system 500 for communicating information and command selections to processor 504. Other non-limiting, illustrative examples of input device 514 include a mouse, a trackball, or cursor direction keys for communicating direction information and command selections to processor 504 and for controlling cursor movement on display 512. While only one input device 514 is depicted in FIG. 5, embodiments may include any number of input devices 514 coupled to computer system 500.

Embodiments described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for publishing a recipe, the method being implemented by one or more processors and comprising:
(a) receiving information from a recipe author regarding one or more step of a recipe;
(b) programmatically generating a functionality for facilitating use of the recipe by recipe users; and
(c) enabling the recipe to be published with the functionality in an interactive online medium.

2. The method of claim 1, further comprising augmenting the information received from the recipe author regarding completion of one or more steps of the recipe.

3. The method of claim 1, wherein in performing (a), the method further comprises programmatically making one or more suggestions as to an ingredient, step or sub-step of the recipe for the recipe author to incorporate into the recipe.

4. The method of claim 1, wherein (b) includes enabling a recipe user to specify a unit conversion of a measurement for an ingredient specified in the recipe, and then programmatically applying the unit conversion in presenting the recipe to the recipe user on the interactive online medium.

5. The method of claim 1, wherein (b) includes enabling programmatic generation of a shopping list on the interactive online medium, the shopping list identifying a set of ingredients specified in the recipe.

6. The method of claim 1, wherein (b) includes enabling a recipe user to automatically scale a set of measurements and/or quantities specified in the recipe.

7. The method of claim 1, wherein (b) includes enabling a recipe user to automatically format the recipe for a printer.

8. The method of claim 1, wherein (b) includes:
associating one or more ingredients specified in the recipe with a corresponding nutritional information;
determining a set of nutritional information for a food item created from the recipe; and
enabling the set of nutritional information to be presented along with the recipe on the interactive online medium.

9. The method of claim 1, wherein (b) includes programmatically identifying one or more recipes that are similar to the recipe of the recipe author, and enabling the identified one or more recipes to be presented on the interactive online medium along with the recipe of the recipe author.

10. The method of claim 1, wherein (b) includes identifying one or more recipes that compliment the recipe of the recipe author.

11. The method of claim 1, further comprising:
enabling the recipe author to specify information for the recipe at a first site;
creating, from the information specified by the recipe author, data corresponding to an online interactive recipe;
providing the recipe author with a data item that is associated with the online interactive recipe, the recipe author being able to embed the data item on a resource provided at a location that is remote to the first site;
publishing the online interactive recipe on the resource at the second site when the resource is downloaded.

12. The method of claim 1, further comprising associating one or more media items with one or more steps of the recipe.

13. The method of claim 12, wherein the one or more media items are instructional as to how one or more steps of the recipe are to be performed.

14. An interactive presentation generated on a computer, the interactive presentation comprising:
a recipe content for a food item;
wherein the recipe content identifies (i) a set of ingredients, (ii) quantities of measurements for each of the ingredients in the set, and (iii) instructional content for using the ingredients to prepare the food item;
one or more functional components provided with the recipe content in order to enable alteration or substitution of the set of ingredients, the quantities of measurement, and/or one or more steps that are identified by the instructional content.

15. The interactive presentation of claim 14, wherein the one or more functional components include a scaling component that re-scales the quantities of measurement for the set of ingredients in response to an input from a recipe user.

16. The interactive presentation of claim 14, wherein the one or more functional components include a conversion component that converts a unit of measurement for one or more of the quantities of measurements in response to an input from a recipe user.

17. The interactive presentation of claim 14, wherein the recipe content is provided to the recipe user as part of a web page.

18. The interactive presentation of claim 14, wherein the recipe content is provided to the recipe user through a web application.

19. A system for publishing a recipe, the system comprising:
a memory that stores a collection of recipes;
one or more processors that are associated with a network site, wherein the one or more processors are configured to:
receive input that identifies a recipe from the collection;
generate a transportable data item that corresponds to the recipe, the data item being transportable to trigger the one or more processors, from a location that is specified by the recipe author and remote to the network site;
in response to the data item triggering the one or more processors, publish the recipe in an interactive form at the remote location.

20. The system of claim 19, wherein the data item is structured to be embedded in a resource that is available at the remote location.

21. The system of claim 20, wherein the data item is structured to be triggered in response to the resource being downloaded at the remote location at the remote location.

22. The system of claim 19, wherein the one or more processors are configured to receive information from a recipe author corresponding to one or more step of the recipe.

23. The system of claim 19, wherein the one or more processors are configured to import the recipe from a source that is remote to the system.

24. The system of claim 19, the one or more resources are configured to present functionality for facilitating use of the recipe by recipe users.

25. The system of claim 19, wherein the functionality corresponds to (i) identifying nutritional information associated with the recipe, and presenting the nutritional information to the recipe user.

26. The system of claim 19, wherein the functionality corresponds to re-rescaling the quantities of measurement for the set of ingredients in response to an input from a recipe user.

27. The system of claim 19, wherein the functionality corresponds to converting a unit of measurement for one or more of the quantities of measurements in response to an input from a recipe user.
